(19) United States
(12) Patent Application Publication
(10) Pub. No.: US 2005/0172167 A1
(43) Pub. Date: Aug. 4, 2005

(54) Communication fault containment via indirect detection

(75) Inventors: Kevin R. Driscoll, Maple Grove, MN (US); Brendan Hall, Eden Prairie, MN (US); Philip J. Zumsteg, Shorewood, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 10/993,916

(22) Filed: Nov. 19, 2004

Related U.S. Application Data
(60) Provisional application No. 60/523,900, filed on Nov. 19, 2003.
(60) Provisional application No. 60/523,782, filed on Nov. 19, 2003.
(60) Provisional application No. 60/523,899, filed on Nov. 19, 2003.
(60) Provisional application No. 60/523,783, filed on Nov. 19, 2003.
(60) Provisional application No. 60/523,865, filed on Nov. 19, 2003.

(51) Int. Cl. G06F 11/00

(52) U.S. Cl. 714/26

(57) ABSTRACT

A method for verifying operation of a first component in a single fault tolerant system is provided. The method includes monitoring for an expected action of the system that indirectly identifies the operating condition of the first component to a second component of the system, when the monitored expected action indicates a faulty operating condition, isolating the first component's errant behavior, and when the monitored expected action indicates a proper operating condition, proceeding with normal operation of the system.

### CROSS REFERENCE TO RELATED APPLICATIONS

This application is related to and claims the benefit of the filing date of the following U.S. Provisional Applications:

Ser. No. 60/523,900, entitled “COMMUNICATION FAULT CONTAINMENT VIA INDIRECT DETECTION” filed on Nov. 19, 2003.

Ser. No. 60/523,782, entitled “HUB WITH INDEPENDENT TIME SYNCHRONIZATION,” filed on Nov. 19, 2003.

Ser. No. 60/523,899, entitled “CONTROLLED START UP IN A TIME DIVISION MULTIPLE ACCESS SYSTEM,” filed on Nov. 19, 2003.

Ser. No. 60/523,783, entitled “PARASITIC TIME SYNCHRONIZATION FOR A CENTRALIZED TDMA BASED COMMUNICATIONS GUARDIAN,” filed on Nov. 19, 2003.

Ser. No. 60/523,865, entitled “MESSAGE ERROR VERIFICATION USING CRC WITH HIDDEN DATA,” filed on Nov. 19, 2003.

Each of these provisional applications is incorporated herein by reference.

This application is also related to the following co-pending, non-provisional applications:

Attorney docket number H000531, entitled “ASYNCHRONOUS HUB,” filed on even date herewith.

Attorney docket number H0005066 entitled “CONTROLLING START UP IN A NETWORK,” filed on even date herewith.

Attorney docket number H0005281 entitled “PARASITIC TIME SYNCHRONIZATION FOR A CENTRALIZED COMMUNICATIONS GUARDIAN,” filed on even date herewith.

Attorney docket number H0005061 entitled “MESSAGE ERROR VERIFICATION USING CHECKING WITH HIDDEN DATA,” filed on even date herewith.

Each of these non-provisional applications is incorporated herein by reference.

### BACKGROUND

Typical electronic systems include a number of components that are interconnected to function in concert to provide a selected functionality. Individual components in the system are prone, from time to time, to break down or otherwise operate outside of their normal specifications. The end result of such breakdowns is that the system may fail to perform as expected thereby producing faults. In communication systems, communications may be further disrupted if the fault is allowed to propagate through the system.

Many systems have been developed to prevent the propagation of faults in a system. For example, some systems include so-called “watchdogs” or “guardians” in the transmitter to check for errors prior to transmission. The best coverage for preventing propagation of faults in a communication network is provided by a self-checking pair. This configuration includes a pair of transmitters that must agree bit for bit for a message to be transmitted. The self-checking pair provides near perfect coverage for preventing the propagation of faults in the network.

Many other techniques have also evolved. Many of these techniques involve independent guardian functions that look at the content of the message itself to determine whether the data is faulty. These techniques include, but are not limited to, the use of a cyclic redundancy check (CRC), timers, etc. that determine whether there is a fault with the message based on some aspect of the message itself.

Unfortunately, in many systems, the self-checking pair is too expensive to implement. Further, the other techniques do not provide sufficiently broad enough coverage to prevent the propagation of all significant classes of faults in the network or they are too complex. Complexity has two detriments. First, an increase in complexity means an increase in the probability of hardware failure. Second, increased complexity complicates the proof that the design is correct. Given that the component with the responsibility to stop fault propagation in a network is usually the most important element in a fault-tolerant system, the proof that this design is correct is very important.

Therefore, there is a need in the art for providing better fault coverage with lower complexity in a communication network.

### SUMMARY

Embodiments of the present invention provide improved fault coverage through indirect detection of the operating conditions of component in a system, e.g., faults and proper operating conditions. As further defined below, the term “indirect detection” means that the component that detects a fault does so based on other components' responses to a faulty signal, rather than observing the faulty signal directly.

A method for verifying operation of a first component in a single fault tolerant system is provided. The method includes monitoring for an expected action of the system that indirectly identifies the operating condition of the first component to a second component of the system, when the monitored expected action indicates a faulty operating condition, isolating the first component's errant behavior, and when the monitored expected action indicates a proper operating condition, proceeding with normal operation of the system.

### BRIEF DESCRIPTION OF THE DRAWINGS

FIG. 1 is a block diagram of a system with a guardian function that uses indirect detection of faults.

FIG. 2 is a flow chart of one embodiment of a process for indirect detection of a fault.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

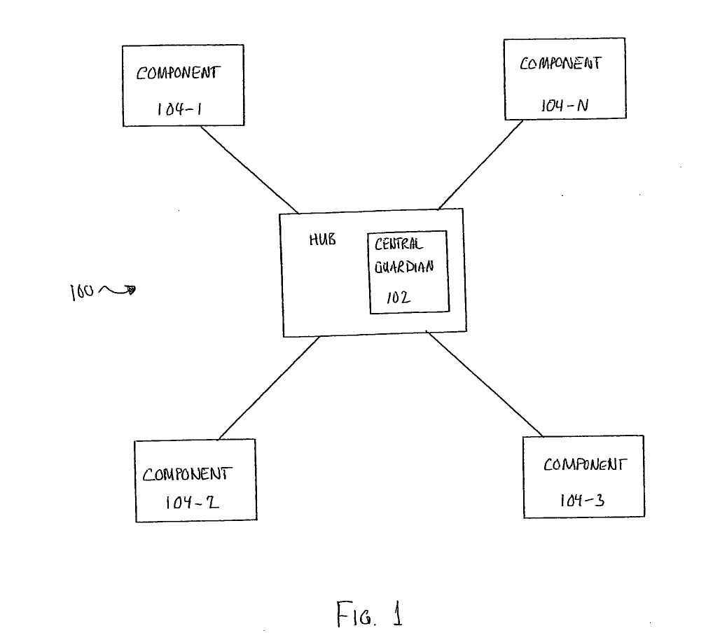

FIG. 1 is a block diagram of a system, indicated generally at 100, with a central guardian function 102 that uses indirect detection of faults. In one embodiment, system 100 is a communication system. In one embodiment, the system 100 uses a time-triggered protocol such as the TTP/C time-triggered protocol. In other embodiments, other TDMA protocols are used.

System 100 includes a plurality of components 104-1 to 104-N, e.g., nodes with transceivers for sending and receiving messages over the system 100. In one embodiment, components 104-1 to 104-N are coupled in a star configuration as shown in FIG. 1. In other embodiments, components 104-1 to 104-N are coupled together in other known or later developed configurations, e.g., a mesh, bus or other appropriate communication architecture. In addition to transceivers, components 104-1 to 104-N may also include other electronic circuitry such as, for example, actuators, sensors, processors, controllers, or the like.

System 100 includes a central component or hub 106. Hub 106 is configured to include the central guardian 102 that uses indirect detection to detect faults in system 100. When a fault is detected, central guardian 102 isolates the node that caused the fault to thereby prevent propagation of the fault. When no fault is detected, the central guardian 102 allows the nodes of the system 100 to operate normally.

As used in the specification, the phrase “indirect detection” means that the component that detects a fault or operating condition of a system component does so based on other components' responses or expected actions to a faulty or good signal, rather than observing the faulty or good signal directly. In some embodiments, the information that is used to indirectly detect a fault or operating condition is based on control signals generated by other components that are used for other specific purposes in the system. In other embodiments, the information is derived from response messages from a number of components.

In operation, central guardian 102 uses indirect detection of an operating condition, e.g., faulty or good, in system 100. Central guardian 102 monitors a condition or an expected action of network 100 to indirectly detect a fault. For example, in one embodiment, central guardian 102 monitors control signals, e.g., beacons (action time signals), Clear to Send signals, or other appropriate control signals. In other embodiments, central guardian 102 monitors other messages, e.g., X frames, or modified CRC or other check value, to isolate faults in the network through indirect detection. Based on the indirect detection of the operating or faulty condition, the guardian isolates the errant behavior of the faulty component.

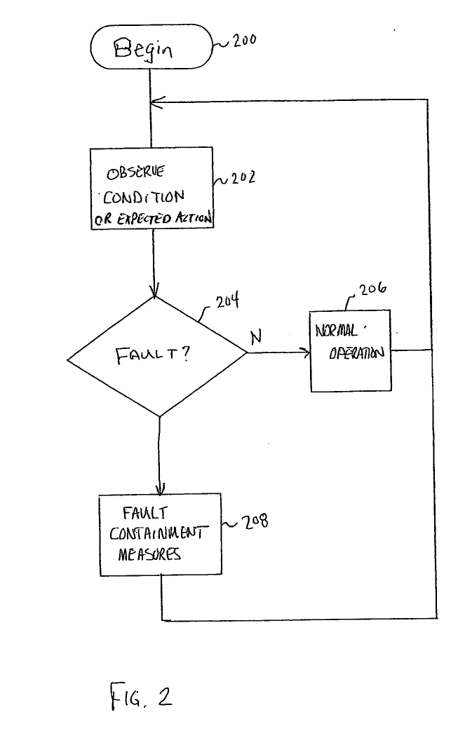

FIG. 2 is a flow chart of one embodiment of a process for indirect detection of a fault in a component of a system having a plurality of components. The method begins at block 200. At block 202, the method monitors a condition or expected action in the system. For example, in one embodiment, the method observes inaction in one component. In another embodiment, the method monitors status information derived by other system components, e.g., a status vector of an X-Frame. In yet another embodiment, the method observes the relative timing of actions of multiple system components. In yet a further embodiment, the method observes conflicting requests for access to system resources. In a further embodiment, the method derives sequencing information from messages communicated in the network.

At block 204, the process analyzes the observed condition or expected action to determine, indirectly, whether the operating condition, e.g., good or faulty, of a component in the system. Continuing the examples from above, if the method observed inaction in one component after a message intended to cause action, then the method identifies a fault condition. On the other hand, if the proper action is observed, the method identifies a good or proper operating condition. In another embodiment, if the status information derived by other system components, e.g., a status vector of an X-Frame, indicates that a component is faulty, then the method determines that the component is faulty without independent analysis of the underlying faulty data. In yet another embodiment, if the method observes the relative timing of actions of multiple system components includes one that falls outside of a system specification, the process identifies a fault condition. On the other hand, if the relative timing of actions falls within normal system parameters, then the process determines that the operating condition of the component is good. In yet a further embodiment, when the method observes conflicting requests for access to system resources, the method identifies a fault condition. Alternatively, when there are no conflicting requests for access to system resources, then the process determines that the components are operating properly. In a further embodiment, when sequencing information derived from messages communicated in the network indicates that a node is transmitting out of turn, the method identifies a fault condition. Alternatively, when the sequencing information matches with the expected order of transmission, the process identifies a proper operating condition.

If there is no fault, the process proceeds with normal operation at block 206 and returns to block 202 to further observe conditions or expected actions in the system. If there is a fault, the process proceeds to block 208 and takes action to prevent the propagation of faults in the system. For example, the method identifies a node as faulty by mapping a number of indirect fault detection observations to an inference of which node is faulty. Further, the method drops further messages generated by the faulty node at least for a period of time or takes other action to prevent the fault from propagating through the network. The method then returns to block 202 to observe further conditions in the system.

Specific examples of the use of indirect detection are described in the co-pending applications incorporated by reference above. Provisional Patent Application Ser. No. 60/523,782, entitled “HUB WITH INDEPENDENT TIME SYNCHRONIZATION,” filed on Nov. 19, 2003 and co-pending application, attorney docket number H000531, entitled “ASYNCHRONOUS HUB,” filed on even date herewith describe a technique for indirectly identifying a fault based on conflicting requests for access to network resources, e.g., the use of the Clear-To-Send signal by two nodes for the same time slot. Provisional Patent Application Ser. No. 60/523,899, entitled “CONTROLLED START UP IN A TIME DIVISION MULTIPLE ACCESS SYSTEM,” filed on Nov. 19, 2003 and co-pending application attorney docket number H0005066 entitled “CONTROLLING START UP IN A NETWORK,” filed on even date herewith describe a technique for indirectly identifying a fault based on a lack of beacons, e.g., action time signals, or other signal normally generated the synchronous mode of operation following a message from a node in an unsynchronized mode of operation. Further, these applications also use indirect detection to detect entry into a synchronized state by observing the transmittal of signals, e.g., guardian messages for voted schedule enforcement or beacons (action time signals) from the many nodes after start up. When the signals are not present, a fault is detected. Provisional Patent Application Ser. No. 60/523,783, entitled “PARASITIC TIME SYNCHRONIZATION FOR A CENTRALIZED TDMA BASED COMMUNICATIONS GUARDIAN,” filed on Nov. 19, 2003 and co-pending application, attorney docket number H0005281 entitled “PARASITIC TIME SYNCHRONIZATION FOR A CENTRALIZED COMMUNICATIONS GUARDIAN,” filed on even date herewith describe a technique that indirectly identifies a fault based on the relative timing of signals. In one embodiment, the signals are beacons such as action time signals. When one beacon falls outside the window of expectation based on the other beacons, the node is declared faulty. Finally, Provisional Patent Application Ser. No. 60/523,865, entitled “MESSAGE ERROR VERIFICATION USING CRC WITH HIDDEN DATA,” filed on Nov. 19, 2003 and co-pending application, attorney docket number H0005061 entitled “MESSAGE ERROR VERIFICATION USING CRC WITH HIDDEN DATA,” filed on even date herewith describe a technique for deriving sequence information from CRC values.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions stored on a machine readable medium to perform desired fluctions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices or machine readable medium suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

1. A method for verifying operation of a first component in a single fault tolerant system, the method comprising:
monitoring for an expected action of the system that indirectly identifies the operating condition of the first component to a second component of the system;
when the monitored expected action indicates a faulty operating condition, isolating the first component's errant behavior; and
when the monitored expected action indicates a proper operating condition, proceeding with normal operation of the system.

2. The method of claim 1, wherein monitoring for an expected action comprises monitoring for beacon signals.

3. The method of claim 1, wherein monitoring for an expected action comprises monitoring the relative timing of beacon signals from a plurality of components.

4. The method of claim 1, wherein monitoring for an expected action comprises monitoring for a message from at least one of a plurality of other components that includes a determination by the at least one of the plurality of other components of the first component's operating condition.

5. The method of claim 1, wherein isolating the first component's errant behavior comprises blocking the component for a period of time.

6. The method of claim 1, wherein proceeding with normal operation comprises transitioning from an asynchronous to a synchronous state based on arrival of at least one beacon signal.

7. The method of claim 1, wherein proceeding with normal operation comprises initiating a time slot based on at least one of a plurality of detected beacon signals.

8. The method of claim 1, wherein monitoring for an expected action comprises monitoring for hidden data in a CRC component of a plurality of messages.

9. A method for detecting and containing a fault in a first component of a system, the method comprising:
observing a condition of the system that indirectly identifies the fault in the first component to another component of the system; and
isolating the first component's errant behavior when the condition indicates a fault.

10. The method of claim 9, wherein observing a condition comprises observing inaction in one or more other component(s) without direct monitoring of the interaction between the first component and the other component(s).

11. The method of claim 9, wherein observing a condition comprises monitoring status information derived by other system components.

12. The method of claim 9, wherein observing a condition comprises comparing the relative timing of actions of multiple system components for compliance with a system specification.

13. The method of claim 9, wherein observing a condition comprises observing conflicting requests for access to system resources.

14. The method of claim 9, wherein observing a condition comprises deriving sequencing information from messages transmitted in the system.

15. A method for indirectly detecting the condition of a node of a communication system, the method comprising:
observing a message from a first node in the communication system;
monitoring for a subsequent action by at least one other node in response to the message by the first node, wherein monitoring for the subsequent action indirectly identifies the condition of the first;
when no action occurs in response to the message, isolating the first node as potentially performing an errant behavior at least for a temporary period; and
when the action occurs, proceeding with normal operation.

16. A method for detecting and containing faults in a communication system having a plurality of nodes, the method comprising:
observing status information in messages from the plurality of nodes in the communication system;
indirectly identifying one of the plurality of nodes as faulty when messages from a sufficient number of the plurality of nodes indicate a fault with the node; and
isolating the node's errant behavior when identified.

17. A method for detecting and containing a fault in one node in a plurality of nodes in a communication system, the method comprising:
monitoring a selected action for a plurality of nodes;
comparing the relative timing of the selected action of the nodes for compliance with a system specification;
when the relative timing of the selected action for one node falls outside an acceptable range, indirectly identifying the node as faulty; and
isolating the first node's errant behavior when the condition indicates a fault.

18. A method for detecting and containing a fault in a node of a communication system, the method comprising:
observing conflicting requests for a system resource, wherein the conflicting requests indirectly identify a fault in a node of the communication system; and
arbitrating between the two conflicting requests to isolate the first node's errant behavior.

19. A method for containing a fault in a communication system comprising indirectly identifying the fault based on observed conditions in the system.

20. A machine-readable medium having instructions stored thereon for a method for detecting and containing a fault in a first component of a system, the method comprising:
observing a condition of the system that indirectly identifies the fault in the first component to another component of the system; and
isolating the first component's errant behavior when the condition indicates a fault.

21. The machine-readable medium of claim 20, wherein observing a condition comprises observing inaction in one or more other component(s) without direct monitoring of the interaction between the first component and the other component(s).

22. The machine-readable medium of claim 20, wherein observing a condition comprises monitoring status information derived by other system components.

23. The machine-readable medium of claim 20, wherein observing a condition comprises comparing the relative timing of actions of multiple system components for compliance with a system specification.

24. The machine-readable medium of claim 20, wherein observing a condition comprises observing conflicting requests for access to system resources.

25. The machine-readable medium of claim 20, wherein observing a condition comprises deriving sequencing information from messages transmitted in the system.

26. An apparatus for detecting and containing a fault in a communication system, the apparatus comprising:
means for observing a condition of the system that indirectly identifies the fault in the first component to another component of the system; and
means for isolating the first component's errant behavior when the condition indicates a fault.

27. A machine-readable medium having instructions stored thereon for a method for verifying operation of a first component in a single fault tolerant system, the method comprising:
monitoring for an expected action of the system that indirectly identifies the operating condition of the first component to a second component of the system;
when the monitored expected action indicates a faulty operating condition, isolating the first component's errant behavior; and
when the monitored expected action indicates a proper operating condition, proceeding with normal operation of the system.

28. The machine-readable medium of claim 27, wherein monitoring for an expected action comprises monitoring for beacon signals.

29. The machine-readable medium of claim 27, wherein monitoring for an expected action comprises monitoring the relative timing of beacon signals from a plurality of components.

30. The machine-readable medium of claim 27, wherein monitoring for an expected action comprises monitoring for a message from at least one of a plurality of other components that includes a determination by the at least one of the plurality of other components of the first component's operating condition.

31. The machine-readable medium of claim 27, wherein isolating the first component's errant behavior comprises blocking the component for a period of time.

32. The machine-readable medium of claim 27, wherein proceeding with normal operation comprises transitioning from an asynchronous to a synchronous state based on arrival of at least one beacon signal.

33. The machine-readable medium of claim 27, wherein proceeding with normal operation comprises initiating a time slot based on at least one of a plurality of detected beacon signals.

34. The machine-readable medium of claim 27, wherein monitoring for an expected action comprises
monitoring for hidden data in a CRC component of a plurality of messages.
